(19) United States
(12) Patent Application Publication
(10) Pub. No.: US 2023/0002567 A1
(43) Pub. Date: Jan. 5, 2023

(54) EMBEDDED HIGH-MOLECULAR-WEIGHT COMPOSITIONS

(71) Applicant: GOLAN PLASTIC PRODUCTS LTD., Kibbutz Shaar Hagolan (IL)

(72) Inventors: Eyal GRUNER, Kibbuts Shaar Hagolan (IL); Yanir SHAKED, Megiddo (IL); Tal LEIZER, Zichron Yaacov (IL)

(73) Assignee: GOLAN PLASTIC PRODUCTS LTD., Kibbutz Shaar Hagolan (IL)

(21) Appl. No.: 17/782,028

(22) PCT Filed: Dec. 2, 2019
(86) PCT No.: PCT/IL2019/051324

§ 371 Date: Jun. 2, 2022

(51) Int. Cl. C08J 3/20; C08J 3/00; C11B 9/00

(52) U.S. Cl. CPC C08J 3/201; C08J 3/005; C11B 9/00; C08J 2323/06; C08J 2491/00

(57) ABSTRACT

A method for embedding a first component in a high molecular weight second component is disclosed. Embedded high-molecular-weight compositions are also disclosed.

### CROSS REFERENCE TO RELATED APPLICATIONS

This application claims the benefit of priority of U.S. Provisional Patent Application No. 62/774,268 entitled “EMBEDDED HIGH-MOLECULAR-WEIGHT COMPOSITIONS”, filed Dec. 2, 2018, the contents of which is incorporated herein by reference in its entirety.

### FIELD OF THE INVENTION

The present invention is in the field of embedded high-molecular-weight compositions and methods for the preparation thereof.

### BACKGROUND OF THE INVENTION

Polymers and plastics have many desirable mechanical properties and can be readily synthesized and manufactured in any desired shape and size. There are many uses for these materials, such as in the form of tubing, pipes, conduits, and the like. There is a need to find efficient methods for absorbing substances into such polymers and plastics without deforming them.

### SUMMARY OF THE INVENTION

There is provided, in accordance with some embodiments, a method for embedding a first component in a high molecular weight second component comprising the steps of mixing the first component with the high molecular weight second component, thereby obtaining a mixture, heating the mixture at a heating temperature above the high molecular weight second component melting point and bellow the first component boiling point, for a period of time, and cooling the mixture to room temperature, thereby embedding the first component in the high molecular weight second component.

In some embodiments, the method further comprises the step of removing remaining non-embedded first component.

In some embodiments, the heating temperature is in the range of 0.1° C. to 200° C. above the melting temperature of the polymer.

In some embodiments, the first component and the high molecular weight second component are used in a ratio of 1:100 to 5:1 (w/w).

In some embodiments, the period of time is in the range of 20 minutes to 72 hours (h).

In some embodiments, the first component is in the form of a liquid at the heating temperature.

In some embodiments, the first component comprises an organic compound, water, a solvent or any combination thereof.

In some embodiments, the organic compound comprises one or more lipids, organic oils, salts, waxes or any combination thereof.

In some embodiments, 10% to 100% of the total amount of the high molecular weight second component is in the form of a solid during the process.

In some embodiments, 20% to 100% of the total amount of the first component is absorbed in the high molecular weight second component.

In some embodiments, the high molecular weight second component comprises a high molecular weight polymer.

In some embodiments, the high molecular weight polymer has an average molecular weight of at least 20,000.

In some embodiments, the high molecular weight second component comprises a crosslinked polymer.

In some embodiments, the polymer comprises high-density polyethylene (HDPE).

In some embodiments, the method is performed in a closed environment.

In some embodiments, the closed environment is a sealed container.

In some embodiments, embedding a first component in a high molecular weight second component, doesn't alter the shape of the high molecular weight second component.

There is provided, in accordance with some embodiments, a polymeric composition comprising a first component and a high molecular weight second component in a ratio of 1:100 to 5:1 (w/w), wherein the first component is embedded in the high molecular weight second component.

In some embodiments, the composition is in the form of a solid.

In some embodiments, the first component comprises one or more organic oils, waxes or a combination thereof.

In some embodiments, the high molecular weight second component comprises a high molecular weight polymer.

In some embodiments, the high molecular weight polymer has an average molecular weight of at least 20,000.

In some embodiments, the high molecular weight second component comprises a crosslinked polymer.

In some embodiments, the polymer comprises crosslinked HDPE.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIGS. 1A-1C present pictures of two different types of cross-linked polyethylene (PEX) (FIG. 1A and FIG. 1B), and a 50:50 mixture of the two PEX types (FIG. 1C);

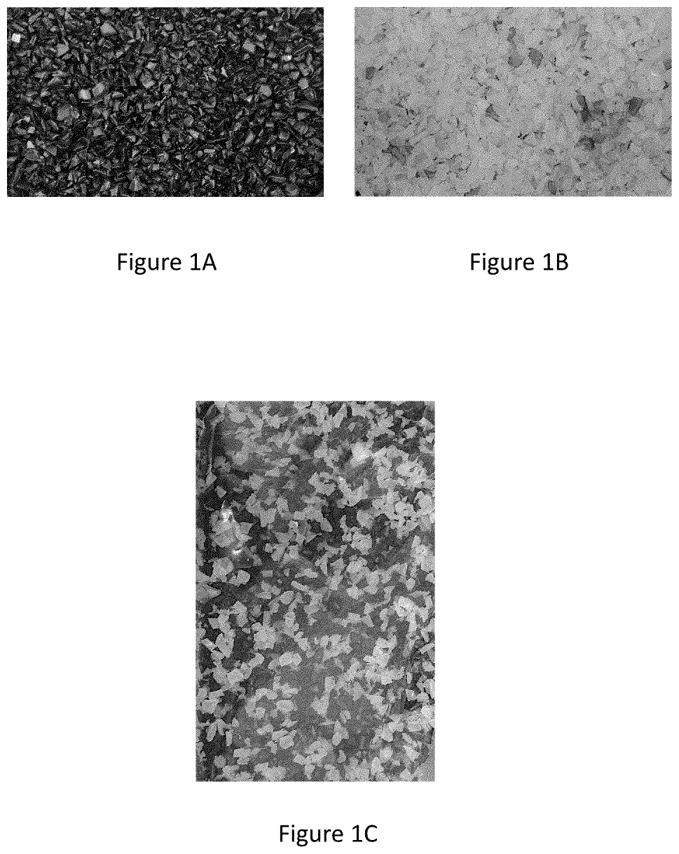

FIGS. 2A-2C present pictures of samples after 48 hours at 110 degrees: active substance 1 sample (FIG. 4A), active substance 2 sample (FIG. 4B), active substance 3 sample (FIG. 4C);

FIGS. 3A-3F present pictures of samples after removal from the bottles; active substance 3 sample (FIG. 3A), active substance 5 sample (FIG. 3B), active substance 4 sample (FIG. 3C), active substance 2 sample (FIG. 3D), active substance 1 sample (FIG. 3E), and reference (FIG. 3F);

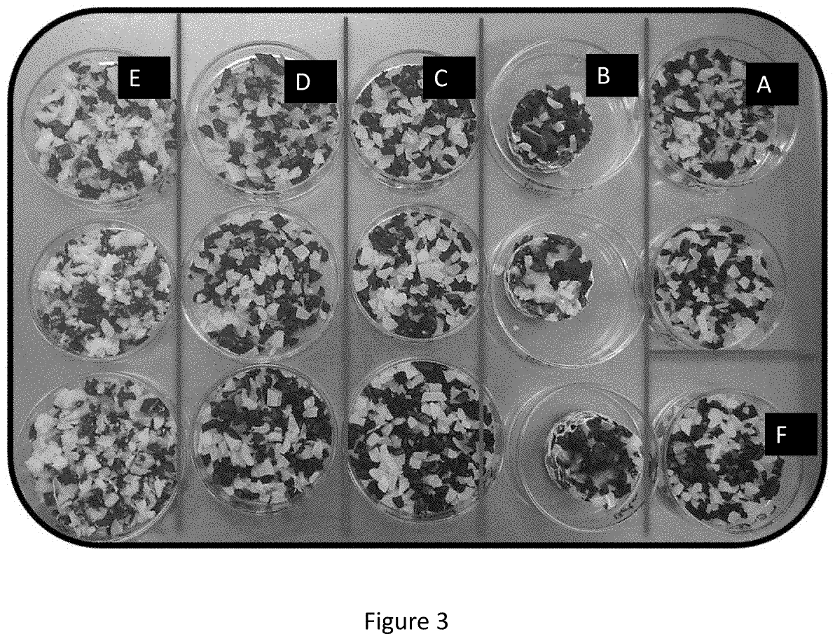

FIG. 4 shows a graph of the weight percent change of PEX samples after absorption at 110° C.;

FIG. 5 presents a graph of the weight loss depending on time (adsorption at 110 degrees);

FIG. 6 presents a table with a percentage of absorbed material (impregnation process performed at 110° C.);

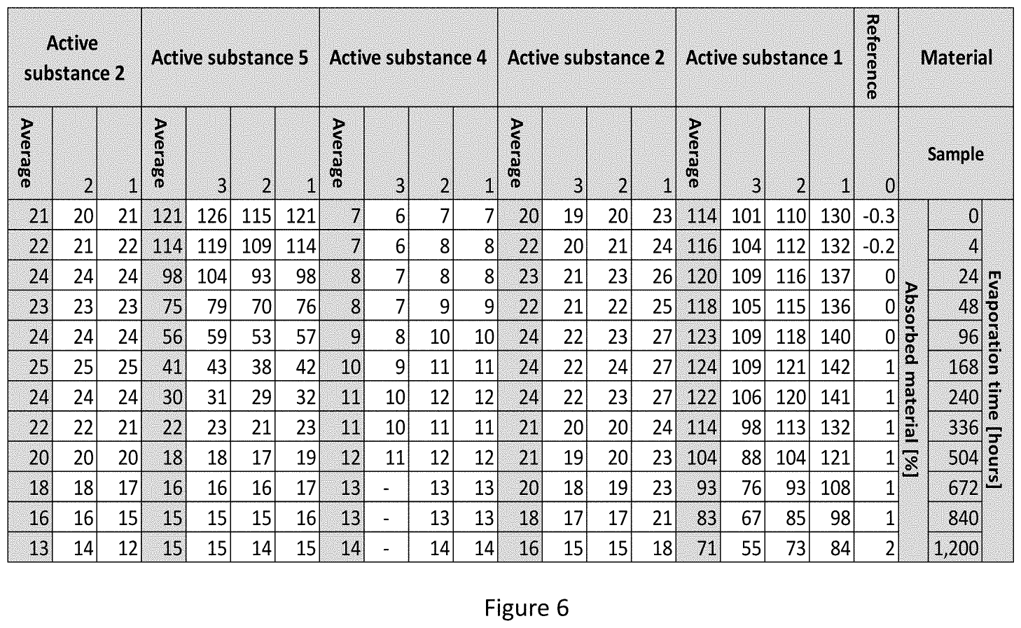

FIGS. 7A-7F present pictures of samples after removal from the bottles; active substance 3 sample (FIG. 7A), active substance 5 sample (FIG. 8B), active substance 4 sample (FIG. 7C), active substance 2 sample (FIG. 7D), active substance 1 sample (FIG. 7E), and reference (FIG. 7F);

FIG. 8 presents a graph of the weight percent change of PEX samples after absorption at 150° C.;

FIG. 9 presents a graph of the weight loss of the active substance, as is (not absorbed onto PEX);

FIG. 10 presents a graph of the weight loss depending on time (adsorption at 150 degrees);

FIG. 11 presents a table with a percentage of absorbed material (impregnation process performed at 150° C.);

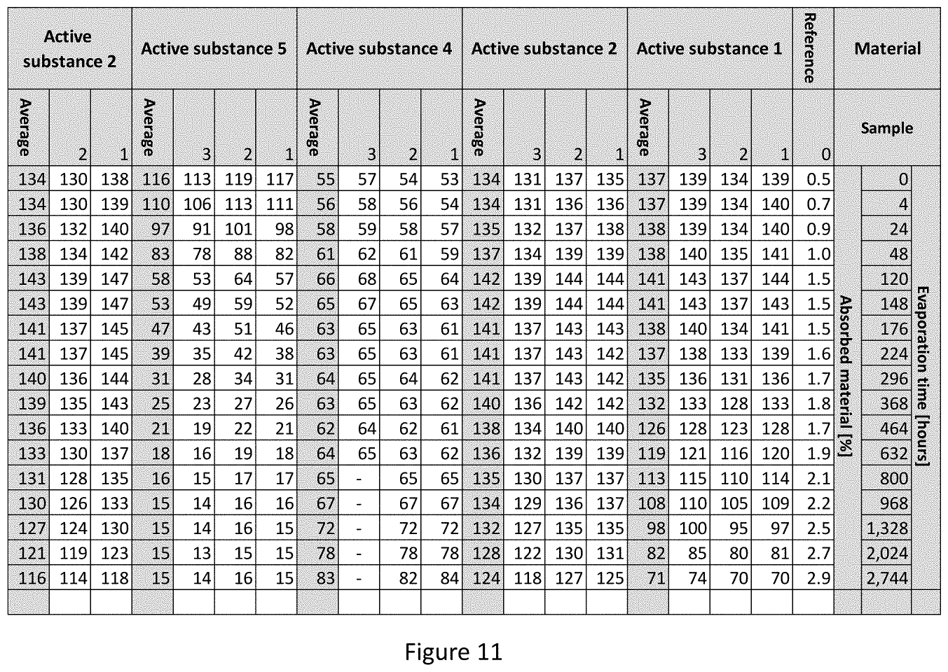

FIG. 12 presents pictures of substances 1-3 absorbed by the PEX particles.

FIG. 13 presents a graph of the weight loss (in %) for each sample (1-5).

### DETAILED DESCRIPTION OF THE INVENTION

According to one aspect, there is provided a method for embedding a first component in a high molecular weight-second component.

According to some embodiments, there is provided a method for embedding a first component in a high molecular weight-second component, comprising the steps of mixing a first component with a high molecular weight second component, thereby obtaining a mixture, heating the mixture at a heating temperature above the high molecular weight second component melting point and bellow the first component boiling point, for a period of time, and cooling the mixture to room temperature, thereby embedding a first component in a high molecular weight second component. In some embodiments, the method further comprises the step of removing the remaining non-embedded first component.

In some embodiments, there is provided a low shear method for embedding a first component in a high molecular weight second component. In some embodiments, there is provided a stress-free method for embedding a first component in a high molecular weight second component.

In some embodiments, the heating temperature is in the range of 0.1° C. to 200° C. above the melting temperature of a high molecular weight second component. In some embodiments, the temperature is in the range of 0.1° C. to 180° C., 0.1° C. to 160° C., 0.1° C. to 150° C., 0.1° C. to 140° C., 0.1° C. to 120° C., 0.1° C. to 100° C., 0.1° C. to 90° C., 0.1° C. to 80° C., 0.1° C. to 70° C., 0.1° C. to 65° C., 0.1° C. to 60° C., 0.1° C. to 55° C., 0.1° C. to 50° C., 0.5° C. to 200° C., 0.9° C. to 200° C., 1° C. to 200° C., 5° C. to 200° C., 10° C. to 200° C., 10° C. to 55° C., or 0.5° C. to 70° C. above the melting temperature of a high molecular weight second component, including any range therebetween.

In some embodiments, the temperature is in the range of 0.1° C. to 200° C. bellow the first component boiling point. In some embodiments, the temperature is in the range of 0.1° C. to 180° C., 0.1° C. to 160° C., 0.1° C. to 150° C., 0.1° C. to 140° C., 0.1° C. to 120° C., 0.1° C. to 100° C., 0.1° C. to 90° C., 0.1° C. to 80° C., 0.1° C. to 70° C., 0.1° C. to 65° C., 0.1° C. to 60° C., 0.1° C. to 55° C., 0.1° C. to 50° C., 0.5° C. to 200° C., 0.9° C. to 200° C., 1° C. to 200° C., 5° C. to 200° C., 10° C. to 200° C., 10° C. to 55° C., 0.1° C. to 10° C., 0.1° C. to 20° C., or 0.5° C. to 70° C. bellow the first component boiling point, including any range therebetween.

In some embodiments, there is provided a method for embedding a first component in a high molecular weight-second component, comprising the steps of mixing a first component with a high molecular weight second component, thereby obtaining a mixture, heating the mixture at a heating temperature above the high molecular weight second component melting point and above the first component boiling point, for a period of time, and cooling the mixture to room temperature, thereby embedding a first component in a high molecular weight second component. In some embodiments, the method further comprises the step of removing the remaining non-embedded first component. In some embodiments, a heating temperature is the boiling point temperature of the first component.

In some embodiments, a heating temperature is 0.1° C. to 180° C., 0.1° C. to 160° C., 0.1° C. to 150° C., 0.1° C. to 140° C., 0.1° C. to 120° C., 0.1° C. to 100° C., 0.1° C. to 90° C., 0.1° C. to 80° C., 0.1° C. to 70° C., 0.1° C. to 65° C., 0.1° C. to 60° C., 0.1° C. to 55° C., 0.1° C. to 50° C., 0.5° C. to 200° C., 0.9° C. to 200° C., 1° C. to 200° C., 5° C. to 200° C., 10° C. to 200° C., 10° C. to 55° C., 0.1° C. to 10° C., 0.1° C. to 20° C., or 0.5° C. to 70° C., above the boiling point temperature of the first component, including any range therebetween.

In some embodiments, a heating temperature is maintained constant for a period of time. In some embodiments, a period of time is in the range of 20 minutes to 72 hours. In some embodiments, a period of time is in the range of 20 minutes to 60 hours, 20 minutes to 48 hours, 20 minutes to 45 hours, 20 minutes to 10 hours, 20 minutes to 5 hours, 20 minutes to 2 hours, 20 minutes to 1 hour, 20 Minutes to 45 minutes, 30 minutes to 72 hours, 40 minutes to 72 hours, 1 hour to 72 hours, 2 hours to 72 hours, 5 hours to 72 hours, 10 hours to 72 hours, or 24 hours to 72 hours, including any range therebetween.

In some embodiments, a first component and a high molecular weight-second component are used in a ratio of 1:100 to 5:1 (w/w). In some embodiments, a first component and a high molecular weight-second component are used in a ratio of 1:90 to 5:1 (w/w), 1:80 to 5:1, (w/w) 1:70 to 5:1 (w/w), 1:50 to 5:1 (w/w), 1:40 to 5:1 (w/w), 1:20 to 5:1 (w/w), 1:10 to 5:1 (w/w), 1:100 to 1:1 (w/w), 1:100 to 2:1 (w/w), 1:100 to 3:1 (w/w), or 1:100 to 4:1 (w/w), including any range therebetween.

In some embodiments, a mixture of a first component and a high molecular weight second component is heated at a temperature above the high molecular weight second component melting point and bellow the first component boiling point for a period of time. In some embodiments, a period of time is in the range of 20 minutes to 72 hours. In some embodiments, a period of time is in the range of 20 minutes to 60 hours, 20 minutes to 48 hours, 20 minutes to 45 hours, 20 minutes to 10 hours, 20 minutes to 5 hours, 20 minutes to 2 hours, 20 minutes to 1 hour, 20 Minutes to 45 minutes, 30 minutes to 72 hours, 40 minutes to 72 hours, 1 hour to 72 hours, 2 hours to 72 hours, 5 hours to 72 hours, 10 hours to 72 hours, or 24 hours to 72 hours, including any range therebetween.

In some embodiments, a mixture of a first component and a high molecular weight second component is heated at a temperature above the high molecular weight second component melting point and bellow the first component boiling point for a period of time long enough for obtaining the maximum embedding of the first component in the high molecular weight second component. In some embodiments, a period of time is a period of time long enough for obtaining a predetermined embedded quantity of a first component in a high molecular weight second component.

In some embodiments, a predetermined embedded quantity of a first component is 1%, 5%, 10%, 15%, 20%, 30%, 40%, 50%, 60%, 70%, 80%, 90%, 95%, 98%, or 99%, of the total quantity of a first component, including any value therebetween.

In some embodiments, a predetermined embedded quantity of a first component is 1% to 100%, 5% to 100%, 5% to 99%, 5% to 98%, 5% to 95%, 5% to 90%, 5% to 85%, 5% to 80%, 5% to 70%, 5% to 60%, 5% to 50%, 10% to 100%, 20% to 100%, 30% to 100%, or 40% to 80%, of the total quantity of a first component, including any range therebetween.

In some embodiments, after cooling the mixture to room temperature, the amount of a first component embedded in the high molecular weight second component can be determined. In some embodiments, a first component is fully embedded in a high molecular weight second component. In some embodiments, a first component is partially embedded in a high molecular weight second component.

In some embodiments, 20% to 100% of the total amount of a first component is absorbed in a high molecular weight second component.

In some embodiments, the removing of the remaining non-embedded first component, is done via filtration. In some embodiments, the remaining non-embedded first component is filtered out using filters. In some embodiments, the remaining non-embedded first component, is recycled.

In some embodiments, mixing a high molecular weight second component with a first component, thereby obtaining a mixture, and heating the mixture at a heating temperature above the high molecular weight second component melting point and bellow the first component boiling point, for a period of time, is done under agitation.

In some embodiments, the method according to the present invention is performed in a closed environment. In some embodiments, the method according to the present invention is performed in a sealed container. In some embodiments, the sealed container is under agitation. In some embodiments, the sealed container is maintained under agitation to prevent agglomeration of the mixture. In some embodiments, the sealed container is maintained under agitation to ensure uniformity of the exposure of the substances to each other.

In some embodiments, there is provided a method for embedding a first component in a high molecular weight-second component, comprising the step of heating at a heating temperature above the high molecular weight second component melting point and bellow the boiling point of the first component. In some embodiments, heating at a heating temperature above the high molecular weight second component melting point increases at least 1 fold, at least 10 fold, at least 50 fold, at least 100 fold, at least 200 fold, at least 500 fold, at least 1000 fold, the effectiveness of embedding a first component in a high molecular weight-second component, compared to heating at a heating temperature bellow high molecular weight second component melting point, including any value therebetween.

First Component

In some embodiments, a first component is in the form of a liquid at a heating temperature as described elsewhere herein. In some embodiments, a first component is in the form of a liquid at the absorption window temperature.

In some embodiments, a first component has low viscosity at a heating temperature as described elsewhere herein.

As used herein the term “absorption window” refers to a temperature range in which a first component is absorbed in a high molecular weight second component.

As used herein the term “organic compound” refers to any class of chemical compounds in which one or more atoms of carbon are covalently linked to atoms of other elements, most commonly hydrogen, oxygen, or nitrogen. In some embodiments, the term “organic compound” refers to an organic compound existing as stable discrete molecules (i.e., non-polymeric).

In some embodiments, a first component comprises at least two compounds. In some embodiments, a first component comprises 3, 4, 5, 6, 7, 8, 9, 10, or 50 compounds, including any value therebetween.

In some embodiments, a first component comprises an organic compound, water, solvent, or any mixture thereof. In some embodiments, a first component comprises an organic compound. In some embodiments, an organic compound comprises one or more lipids, organic oils, salts, waxes or any combination thereof.

In some embodiments, a first component comprises a low molecular weight compound.

In some embodiments, a first component is in the form of a solid, a salt, a solution, an emulsion, or a suspension, at room temperature. In some embodiments, a first component melts at a heating temperature as described elsewhere herein.

In some embodiments, 20% to 100% of the total amount of a first component is absorbed in a high molecular weight second component. In some embodiments, 25% to 100%, 30% to 100%, 40% to 100%, 50% to 100%, 60% to 100%, 70% to 100%, 80% to 100%, or 90% to 100% of the total amount of a first component is absorbed in a high molecular weight second component, including any range therebetween.

In some embodiments, a first component has a lower viscosity than a high molecular weight second component.

In some embodiments, a first component has a viscosity at least 0.01%, at least 0.1%, at least 0.5%, at least 1%, at least 5%, at least 10%, at least 20%, at least 40%, at least 50%, at least 100%, at least 1000%, lower than a high molecular weight second component, including any value therebetween.

In some embodiments, a first component has a lower molecular weight than a high molecular weight second component. In some embodiments, a first component has a molecular weight at least 0.01%, at least 0.1%, at least 0.5%, at least 1%, at least 5%, at least 10%, at least 20%, at least 40%, at least 50%, at least 100%, at least 1000%, lower than a high molecular weight second component, including any value therebetween.

In some embodiments, the lower molecular weight first component is embedded in the high molecular weight second component when the mixture is cooled to room temperature. In some embodiments, the lower molecular weight first component is partially embedded in the high molecular weight second component. In some embodiments, the lower molecular weight first component is fully embedded in the high molecular weight second component.

In some embodiments, the lower molecular weight first component comprises an oil with repellent properties. In some embodiments, the lower molecular weight first component comprises an oil with animal repellent properties.

In some embodiments, a composition according to the present invention comprising a lower molecular weight first component with repellent properties embedded in the high molecular weight second component, increases the effectiveness of the repelling composition by providing resistance to water and other elements.

In some embodiments, a composition according to the present invention comprising a lower molecular weight first component with repellent properties embedded in the high molecular weight second component, increases at least 10%, at least 20%, at least 30%, at least 40%, at least 50%, at least 70%, at least 100% at least 200% the effectiveness of the repelling composition when compared to similar composition with a first component with repellent properties coating the high molecular weight second component.

In some embodiments, a composition according to the present invention comprising a lower molecular weight first component with repellent properties embedded in the high molecular weight second component, increases at least 1 fold, at least 10 fold, at least 50 fold, at least 100 fold, at least 200 fold, at least 500 fold, at least 1000 fold, the effectiveness of the repelling composition when compared to similar composition with a first component with repellent properties coating the high molecular weight second component, including any value therebetween.

In some embodiments, a lower molecular weight first component with repellent properties embedded in the high molecular weight second component, is gradually released from the high molecular weight second component. In some embodiments, the released lower molecular weight first component has aromatherapy, fragrance, insecticidal and insect repelling properties.

In some embodiments, the lower molecular weight first component comprises a mixture of one or more oils with repellent properties and one or more insecticide. In some embodiments, an insecticide is an oil soluble insecticide. Non-limiting examples of oils include cedar oil, cinnamon oil, citronella oil, clove oil, eugenol, geraniol, geranium oil, lemongrass oil, mint oil, peppermint oil, rosemary oil and thyme oil. Non-limiting examples of insecticides include synthetic pyrethroids, methomyl, phosmet, dimethyl dichlorovinyl phosphate (DDVP), chlorpyrofos and the like.

In some embodiments, the lower molecular weight first component comprises a fragrance. In some embodiments, the term “fragrance” is synonymous with perfume. In some embodiments, the term “fragrance” means scent. In another embodiment, the term “fragrance” means aroma. In some embodiments, the term “fragrance”, includes but is not limited to, conventional fragrances known in the art, including but not limited to, U.S. Pat. No. 4,145,184, Brain and Cummins, issued Mar. 20, 1979; U.S. Pat. No. 4,209,417, Whyte, issued Jun. 24, 1980; U.S. Pat. No. 4,515,705, Moeddel, issued May 7, 1985; and U.S. Pat. No. 4,152,272, Young, issued May 1, 1979.

In some embodiments, the fragrance comprises an essential oil.

Non-limiting examples of essential oils comprise but are not limited to: lavender oil, peppermint oil, tea tree oil, patchouli oil, neroli oil and eucalyptus oil, including any combination thereof.

In some embodiments, the fragrance comprises a volatile fragrance. In some embodiments, the fragrance comprises the essential oil and a volatile fragrance.

In some embodiments, a volatile fragrance has a boiling point of less than about 475 to 525° C. In some embodiments, a volatile fragrance has a boiling point of less than about 475° C. to 515° C. In some embodiments, a volatile fragrance has a boiling point of less than about 485° C. to 515° C. In some embodiments, a volatile fragrance has a boiling point of less than about 495° C. to 505° C. In some embodiments, a volatile fragrance has a boiling point of less than about 500° C.

In some embodiments, a volatile fragrance is a highly volatile fragrance. In some embodiments, highly volatile fragrance means having a boiling point of about 230 to 250° C. In some embodiments, highly volatile fragrance means having a boiling point of about 230° to 245° C. In some embodiments, highly volatile fragrance means having a boiling point of about 235° to 245° C. In some embodiments, highly volatile fragrance means having a boiling point of about 250° C.

Non-limiting examples of highly volatile fragrance comprise but are not limited to: anethole, benzaldehyde, benzyl acetate, benzyl alcohol, benzyl formate, iso-bornyl acetate, camphene, cis-citral (neral), citronellal, citronellol, citronellyl acetate, para-cymene, decanal, dihydrolinalool, dihydromyrcenol, dimethyl phenyl carbinol, eucalyptol. geranial, geraniol, geranyl acetate, geranyl nitrile, cis-3-hexenyl acetate, hydroxycitronellal, d-limonene, linalool, linalool oxide, linalyl acetate, linalyl propionate, methyl anthranilate, alpha-methyl ionone, methyl nonyl acetaldehyde, methyl phenyl carbinyl acetate, laevo-menthyl acetate, menthone, iso-menthone. myrcene, myrcenyl acetate, myrcenol, nerol, neryl acetate, nonyl acetate, phenyl ethyl alcohol, alpha-pinene, beta-pinene, gamma-terpinene, alpha-terpineol, beta-terpineol, terpinyl acetate, and vertenex (para-tertiarybutyl cyclohexyl acetate) and any combination thereof.

In some embodiments, a volatile fragrance is a moderately volatile fragrance. In some embodiments, a moderately volatile fragrance means having a boiling point between 250 to 300° C. In some embodiments, a moderately volatile fragrance means having a boiling point between 250 to 300° C. In some embodiments, a moderately volatile fragrance means having a boiling point between 250 to 290° C. In some embodiments, a moderately volatile fragrance means having a boiling point between 260 to 290° C. In another embodiment a moderately volatile fragrance means having a boiling point between 260 to 280° C.

Non-limiting examples of moderately volatile fragrances comprise but are not limited to: amyl cinnamic aldehyde, iso-amyl salicylate, beta-caryophyllene, cedrene, cinnamic alcohol, coumarin, dimethyl benzyl carbinyl acetate, ethyl vanillin, eugenol, iso-eugenol, for acetate, heliotropine, 3-cis-hexenyl salicylate, hexyl salicylate, lilial (para-tertiarybutyl-alpha-methyl hydrocinnamic aldehyde), gamma-methyl ionone, nerolidol, patchouli alcohol, phenyl hexanol, beta-selinene, trichloromethyl phenyl carbinyl acetate, triethyl citrate, vanillin, veratraldehyde and any combination thereof.

In some embodiments, a volatile fragrance is a less volatile fragrance. In some embodiments, a less volatile fragrance means having a boiling point of about 300 to 500° C. In some embodiments, a less volatile fragrance means having a boiling point of about 300 to 450° C. In some embodiments, a less volatile fragrance means having a boiling point of about 350 to 450° C.

Non-limiting examples of less volatile fragrances comprise but are not limited to:

benzophenone, benzyl salicylate, ethylene brassyiate, galaxolide (1,3,4,6,7,8-hexahydro-4,6,6,7,8,8-hexamethyl-cyclopenta-gama-2-benzopyran), hexyl cinnamic aldehyde, lyral (4-(4-hydroxy-4-methyl pentyl)-3-cyclohexene-10-carboxaldehyde), methyl cedrylone, methyl dihydro jasmonate, methyl-beta-naphthyl ketone, musk indanone, musk ketone, musk tibetene, phenylethyl phenyl acetate and any combination thereof.

In some embodiments, a composition according to the present invention comprising the fragrance embedded within the high molecular weight second component is characterized by fragrance releasing properties. In some embodiments, the composition comprising the fragrance embedded within the high molecular weight second component is a fragrance releasing composition. In some embodiments, the fragrance releasing composition increases at least 10%, at least 20%, at least 30%, at least 40%, at least 50%, at least 70%, at least 100% at least 200% the effectiveness of the fragrance release, when compared to a similar composition comprising the fragrance coating the high molecular weight second component.

In some embodiments, the fragrance releasing composition increases at least 1 fold, at least 10 fold, at least 50 fold, at least 100 fold, at least 200 fold, at least 500 fold, at least 1000 fold, the effectiveness of the fragrance release, when compared to a similar composition comprising the fragrance coating the high molecular weight second component.

In some embodiments, the fragrance is gradually released from the fragrance releasing composition. In some embodiments, the released fragrance has aromatherapy, fragrance, insecticidal and insect repelling properties. In some embodiments, the fragrance releasing composition, or the composition is characterized by a sustained release profile of said first component, as shown in the Examples section. In some embodiments, the fragrance releasing composition, or the composition is characterized by a sustained release profile of said first component for at least 10 h, at least 40 h, at least 80 h, at least 100 h, at least 200 h, at least 300 h, at least 500 h, at least 700 h, at least 1000 h, at least 1500 h, at least 1800 h, at least 2000 h, at least 2500 h, at least 3000 h, including any range or value therebetween.

In some embodiments, the fragrance releasing composition, or the composition retains at least 80% by weight of said first component for at least 144 h, as shown in the Examples section. In some embodiments, the fragrance releasing composition, or the composition retains at least 80% by weight of said first component for at least 24 h, at least 48 h, at least 100 h, at least 200 h, at least 300 h, at least 400 h, at least 500 h, at least 600 h, at least 700 h, at least 800 h, at least 1000 h, at least 1500 h, at least 2000 h, including any range or value therebetween.

In some embodiments, the fragrance releasing composition, or the composition retains at least 70% by weight of said first component for at least 24 h, at least 48 h, at least 100 h, at least 200 h, at least 300 h, at least 400 h, at least 500 h, at least 600 h, at least 700 h, at least 800 h, at least 1000 h, at least 1500 h, at least 2000 h, including any range or value therebetween.

In some embodiments, the fragrance releasing composition, or the composition retains at least 60% by weight of said first component for at least 24 h, at least 48 h, at least 100 h, at least 200 h, at least 300 h, at least 400 h, at least 500 h, at least 600 h, at least 700 h, at least 800 h, at least 1000 h, at least 1500 h, at least 2000 h, including any range or value therebetween.

In some embodiments, the fragrance releasing composition, or the composition retains at least 50% by weight of said first component for at least 24 h, at least 48 h, at least 100 h, at least 200 h, at least 300 h, at least 400 h, at least 500 h, at least 600 h, at least 700 h, at least 800 h, at least 1000 h, at least 1500 h, at least 2000 h, including any range or value therebetween.

In some embodiments, a composition according to the present invention comprises an animal repelling effective amount or animal killing effective amount of a lower molecular weight first component embedded in the high molecular weight second component. In some embodiments, a composition according to the present invention works effectively against insects, lizards, snakes, arachnids (spiders, ticks, mites), caterpillars, cockroaches, silver fish, moths, slugs, bees, yellow jackets, beetles, aphids, meal bugs, green flies, horse flies, gnats, mosquitoes, and chiggers.

High Molecular Weight Components

In some embodiments, 10% to 100% of the total amount of a high molecular weight second component is in a solid form during the process. In some embodiments, 20% to 100%, 50% to 100%, 25% to 90%, 30% to 90%, 35% to 90%, 40% to 90%, 45% to 90%, or 50% to 90% of the total amount of a high molecular weight second component is in a solid form during the process.

In some embodiments, a high molecular weight second component comprises a high molecular weight polymer.

In some embodiments, the high molecular weight polymer has an average molecular weight of at least 20,000. In some embodiments, the high molecular weight polymer has an average molecular weight of at least 20,000, at least 50,000, at least 80,000, at least 100,000, at least 200,000, at least 500,000, at least 1,000,000, at least 1,500,000, at least 2,000,000, including any value therebetween. In some embodiments, a high molecular weight polymer has an average molecular weight in the range of 20,000 to 2,000,000. In some embodiments, a high molecular weight polymer has an average molecular weight in the range of 20,000 to 1,750,000, 20,000 to 1,500,000, 50,000 to 2,000,000, 75,000 to 2,000,000, 100,000 to 2,000,000, 500,000 to 2,000,000, 750,000 to 2,000,000, 1,000,000 to 2,000,000, or 1,500,000 to 2,000,000, including any range therebetween.

In some embodiments, a high molecular weight second component comprises a crosslinked polymer. In some embodiments, a high molecular weight second component comprises a polymer comprises HDPE.

As known in the art, crosslinked polymer have quite different mechanical and physical properties than their uncrosslinked linear or branched counterparts. For example, crosslinked polymers may show unique and highly desirable properties such as solvent resistance, high cohesive strength, and elastomeric character. Typically, but not exclusively, the crosslinked polymers are characterized by a plurality of polymeric strands that may be covalently linked together.

In exemplary embodiments, the crosslinked polymer is polyethylene (PEX).

In additional exemplary embodiments, the polymer is high-density polyethylene (HDPE).

In additional exemplary embodiments, the polymer is high-density cross-linked polyethylene.

In some embodiments, a high molecular weight is a typical characteristic of network crosslinked polymers having a certain degree of network crosslinking.

In some embodiments, a high molecular weight second component is in the form of a solid.

As used herein, the term “solid” refers to substances that have three dimensions and have the properties of a solid; namely it is not in liquid or gaseous form. For example, a pipe, piece of plastic, piece of paper, a metal rod, a steel needle, are all considered to be solids in the context of the present invention.

As used herein throughout, the term “polymer” describes an organic substance composed of a plurality of repeating structural units (backbone units) covalently connected to one another.

As used herein, “crosslinked” and/or “crosslinking”, and any grammatical derivative thereof refers to a chemical process or the corresponding product thereof in which two chains of polymeric molecules are attached by bridges (crosslinker) composed of an element, a group or a compound, which join certain carbon atoms of the chains by primary chemical.

As used herein, the term “molecular weight” encompasses any one of the average weight values selected from: Mₙ (Number average molar mass), NAMW (Number Average Molecular Weight), M_{w} (Mass average molar mass), WAMW (Weight Average Molecular Weight), M_{Z} (Z average molar mass), My (Viscosity average molar mass), and MWCO (molecular weight cut-off). Unless stated otherwise this term refers to M.

In some embodiments, a high molecular weight second component comprises one or more polymeric materials, e.g., a plastic.

The term “plastic” as used herein includes natural and synthetic polymers (e.g. elastomers). In some embodiments the term “plastic” refers to one or more polymeric materials which are capable of being extruded (e.g., through a die or similar instrumentality).

In some embodiments, non-limiting examples of high molecular weight second components that can be used according to the present invention are non-recyclable polymeric waste, thermoplastics, non-thermoplastics, or any combination thereof.

A suitable source for a polymer is industrial or domestic waste. Thermosetting polymers may include any polymers which will cross-link e.g., with the application of heat, including, without being limited thereto amide urethane elastomers, chlorinated polyethylene, polyethylene, chloroprene, polyacrylate, polybutadiene, polyester urethane, polyether urethane, polyurethanes, propylene oxide, polystyrene, and thermo-plastic elastomers.

In some embodiments, a high molecular weight second component is selected from the group consisting of: polyurethanes, polypropylenes, cross linked polyethylene, high-density polyethylene, polyamides, polyesters, amide urethane elastomers, chlorinated polyethylene, chloroprene, polyacrylate, polybutadiene, polyester urethane, polyether urethane, propylene oxide, styrenic elastomer, thermos-plastic elastomers, polyvinyl pyrrolidone, a polymethacrylate, polyethylene, polyitaconates, and polyvinyl pyrrolidone.

Additional non-limiting examples are selected from polyvinylchloride (PVC), polyethylene (PE), or polyurethane (PU), substituted and unsubstituted, polyanilines, polyazines, polythiophenes, poly-p-phenylene sulfides, polyfuranes, polyselenophenes, polyacetylenes polyethylene foam, polypropylene foam.

In some embodiments, plastics that may be used include, for example, polyesters such as polyethylene tertphthalate (PET) or polybutylene terephthalate (PBT) or, for example, ethylene-vinyl alcohol copolymers (EVOH) or polyvinylidene fluoride (PVDF).

In some embodiments, a high molecular weight second component comprises a partially crosslinked phase. In some embodiments, a high molecular weight second component preserves at least a portion of its original shape above its melting temperature. In some embodiments, a high molecular weight second component preserves 10% to 100% of its original shape above its melting temperature. In some embodiments, a high molecular weight second component preserves 20% to 100%, 10% to 95, 20% to 90%, 25% to 90%, 30% to 90%, 35% to 90%, 40% to 90%, 45% to 90%, 50% to 100%, or 50% to 90% of its original shape above its melting temperature, including any range therebetween.

In some embodiments, embedding a first component in a high molecular weight second component, doesn't alter the shape of the high molecular weight second component. In some embodiments, at least 50% of the original shape of the high molecular weight second component is maintained in the end of the process. In some embodiments, at least 70%, at least 80%, at least 95%, at least 98%, or at least 99% of the original shape of the high molecular weight second component is maintained in the end of the process, including any value therebetween.

In some embodiments, a high molecular weight second component is in a continuous form. In some embodiments, a high molecular weight second component is in particles form. Non-limiting examples of high molecular weight second component forms and shapes that can be used according to the present invention are pipes, tubes, sheets, 3 dimensional parts, beads, or any combination thereof.

General:

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

Test Method:

1. 5 grams of cross-linked polyethylene (PEX) were weighted and transferred to the glassware.

2. Approximately 10 mL of an active ingredient were inserted into the vessel, or alternatively, an active ingredient was inserted until the PEX sample was completely covered with liquid. The vessel was then closed and sealed. The volume of the vessel is at least 3 times the volume of the material, in favor of propagation.

3. Heating of the PEX+active substance in a sealed vessel was performed in two experimental protocols:

a. 48 hours at a temperature of 110° C. -adsorption in solid state.

b. 6 hours at a temperature of 150° C. -adsorption over the melting temperature of PEX.

4. Heating of PEX reference sample in an opaque vessel was done without active material -according to section 3.

5. The samples were reviewed once every few hours to examine visible changes (change of tone/shape).

6. Cooling was done to the room temperature, removing the PEX from the liquid, filtering out the residues of the liquid, and absorbing with absorbent paper. The used liquid was kept.

7. The samples were weighted, and it was calculated the percentage of material that was included in the PEX particles.

8. Each sample had 3 repetitions at each temperature and for each active substance.

Total of 15 samples at each PEX-14 temperature with active ingredient+1 reference sample, with no active ingredient.

9. The samples were closed in an airtight container and kept in a dark and cool environment until further tests were performed.

Evaporation Rate Test:

1. Samples were placed in an open container (Petri dish) and in environmental conditions and weighted at regular intervals.

2. After removing the material from the liquid, weighing times (in hours) are: zero, 4, 24, 48, etc.

3. Continue weighing tests until a percentage of the of evaporating material in time is observed, or until all absorbed substance evaporated.

4. Grading of active substances and acclimatization protocols based on absorption capacity and evaporation rate.

TABLE 1
Details of materials

| | Boiling |
|---|---|
| Active | Temperature |
| substance | [° C.] |
| 1 | — |
| 2 | 212 |
| 3 | 214-224 |
| 4 | 229-230 |
| 5 | 164-165 |

### Example 1

Addition of Active Substances to Cross-Linked Polyethylene (PEX) at 110° C.

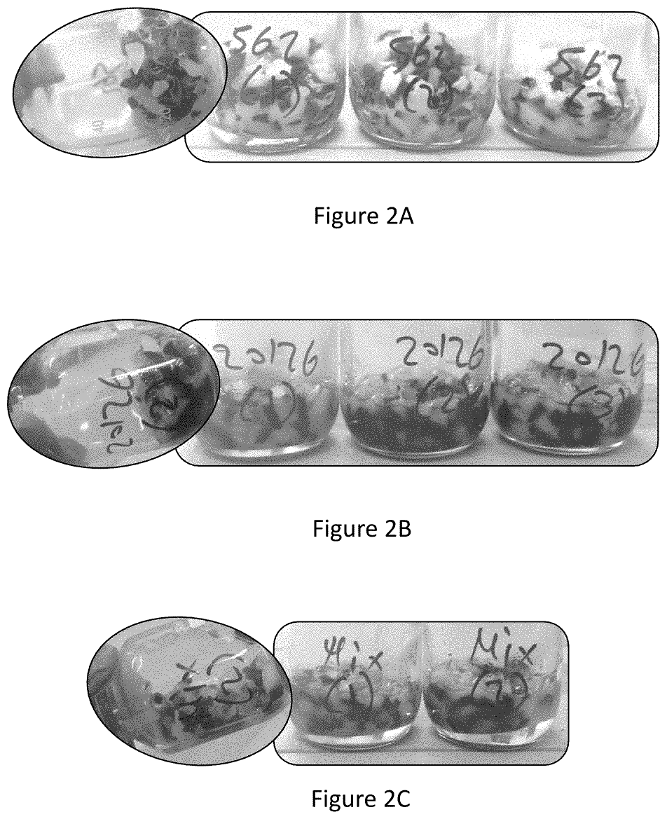

As shown in FIGS. 2A-C, in active substance 1, active substance 2 and active substance 3, a significant portion of the active ingredient appears to be attached to the PEX.

In sample 1 (FIG. 2A), the PEX particles swelled considerably, and in the vessel remained relatively clear liquid. When the sample was extracted, it was possible to observe a number of particles, that dissolved from the PEX and became attached to the glass. After drying the liquid from the surface of the particles, some of the latter appeared yellowish.

In active substance 2 samples (FIG. 2B), a relatively large amount of milky/murky fluid remained without free particles.

In active substance 3 samples (FIG. 2C), there was no free liquid in the vessel, but there was a kind of gel that connects the particles, without free particles.

Regarding active substance 4 samples after 48 hours at 110 degrees, most of the active substance remains adsorbent. The liquid was yellowish and relatively clear, and there are small PEX particles floating in it.

Regarding active substance 5 samples after 48 hours at 110 degrees, a certain amount of active matter remained without adsorption, and the liquid is transparent and clear.

Since the PEX block could not be broken, the samples were extracted by breaking the bottle and then washed with ethanol to remove glass fragments.

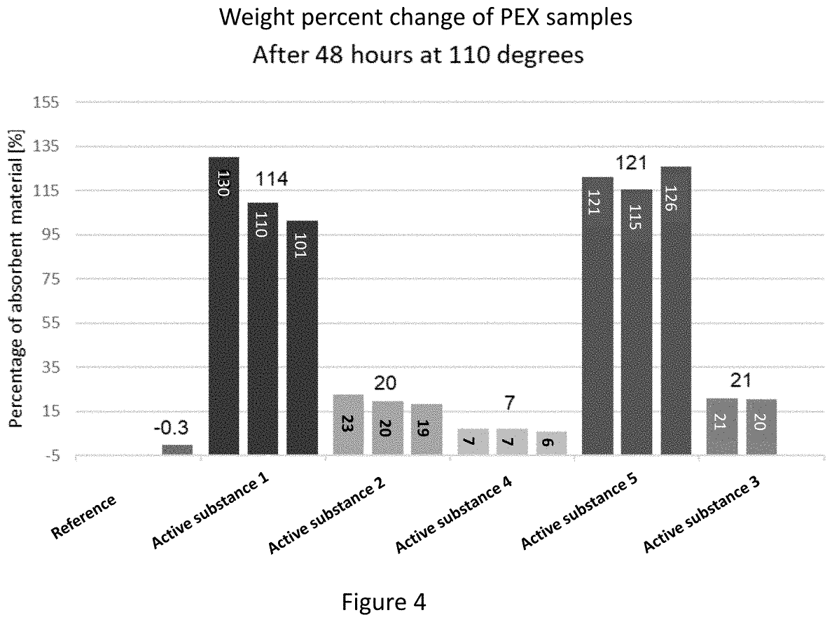

FIG. 4 shows the percentage of adsorption of PEX particles after 48 hours at 110° C.

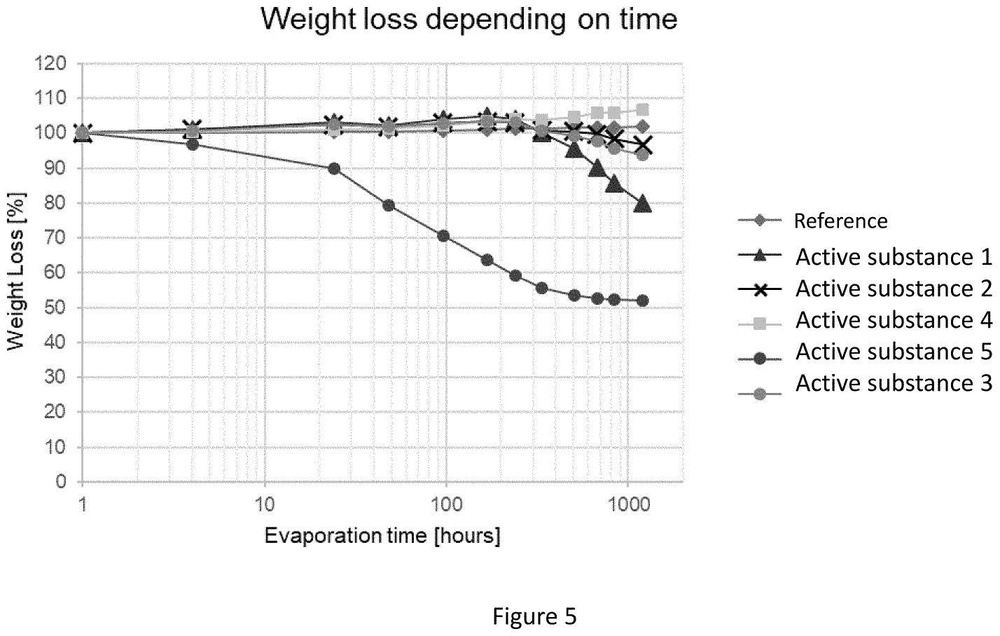

FIG. 5 shows the weight loss depending on time (adsorption at 110 degrees).

The Adsorption Capacity at 110 Degrees:

In all the samples there was a non-additive material and therefore it can be assumed that the PEX particles have exhausted their sorption capacity at this temperature.

The highest adsorption percentage was obtained for active substance 1 and active substance 5 solutions and it was similar to the 150% adsorption percentage, although the distribution of results is greater.

For the other 3 active substances, the adsorption percentage was less than 15% of the 150° C.

The Evaporation Rate:

Active substance 5 evaporation began immediately and after evaporation of about 45% of the absorbent material, the evaporation rate appears to be moderate.

In all of the samples in the walls, there was a certain increase in weight, which probably attests to the absorption of moisture from the air.

Specific weight loss in active substance 1 supplement was observed after about 48 hours, but significant weight loss begins only after about two weeks and even exceeds the 100% supplemental threshold-that is, at least part of the weight loss results from elongating the alcohol.

The rate of adsorption/evaporation of the active substance 3 samples is the same as that of the active substance 2 samples.

In the active substance 4 samples weight gain continues, even after 7 weeks.

### Example 2

### Addition of Active Substances to the PEX at 150° C.

The PEX particles were partially dissolved (mainly the white PEX) and become a lump. In active substance 1, 2 and 3, it seems that the active substance was an appendix to the PEX.

Regarding active substance 4 sample, after 6 hours at 150 degrees much of the active matter remains uncoated, the liquid yellowish and dark. The turbidity may be due to the exhaustion of one of the components of the PEX revaluation.

Regarding active substance 5 sample, after 6 hours at 150 degrees, a certain amount of active matter remains without adsorption, the liquid is transparent and clear.

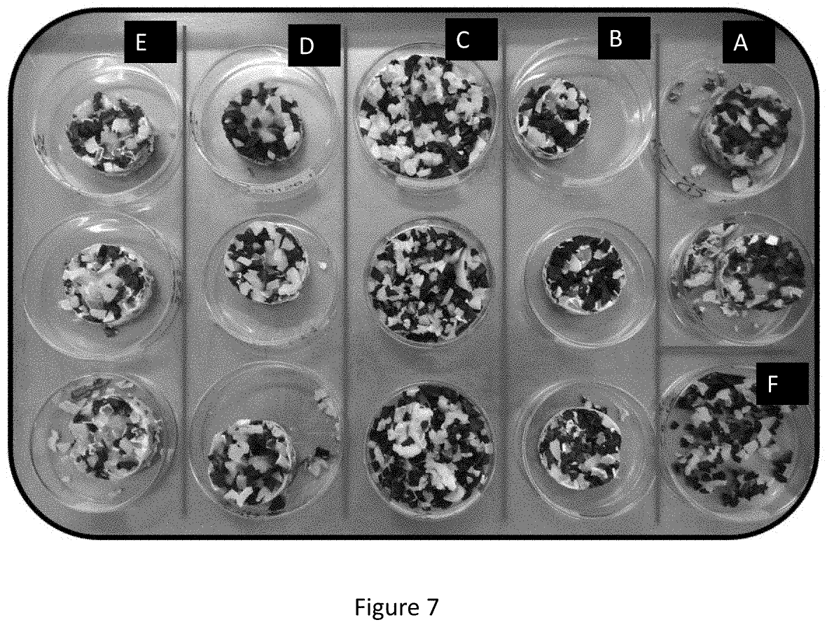

FIGS. 7A-F shows the samples after removal from the bottles.

Active substance 4 sample-The PEX block could be broken and the sample extracted from the bottles.

Active substance 5 sample-The block could not be broken, and the sample was extracted by breaking the bottle.

Active substance 1, 2 and 3 samples-The lump could not be broken, and the sample was glued to the glass. Extract the sample by breaking the bottle. The samples were washed with ethanol to remove impurities (wood chips, glass), originating in the extraction process.

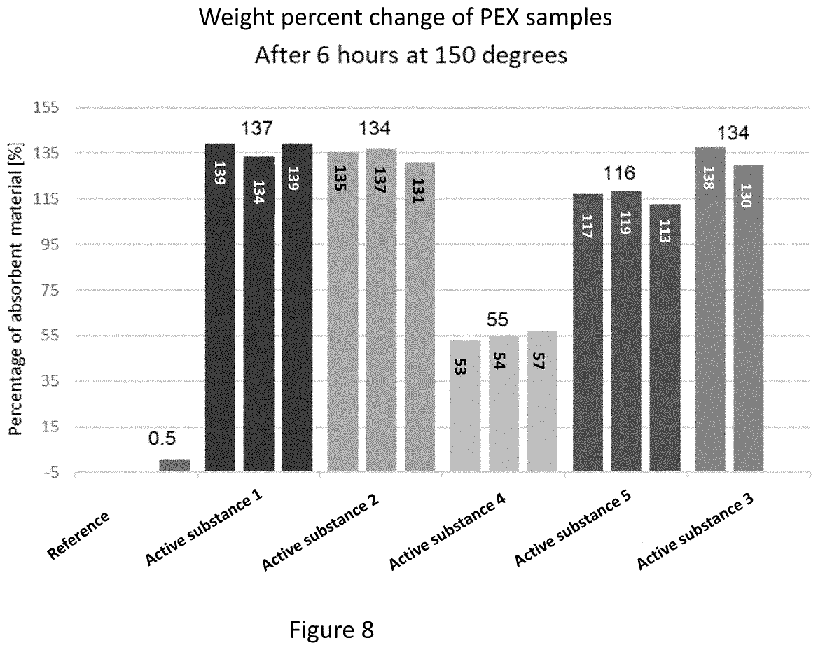

FIG. 8 presents a graph of the percent of adsorption of PEX particles after 6 hours at 150° C.

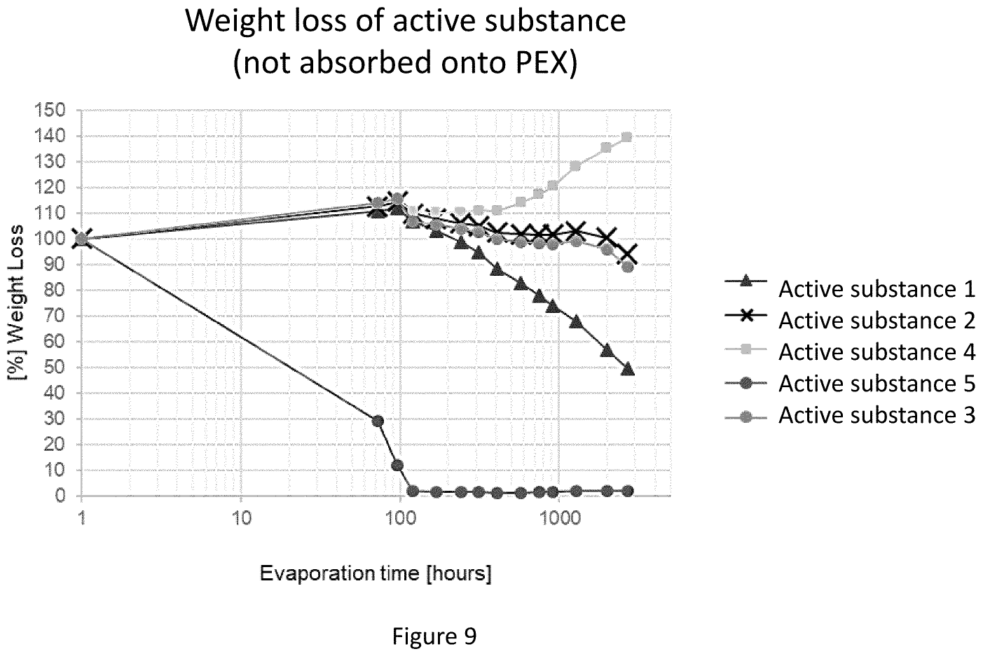

FIG. 9 presents a graph of the weight of the active ingredient depending on time, without PEX.

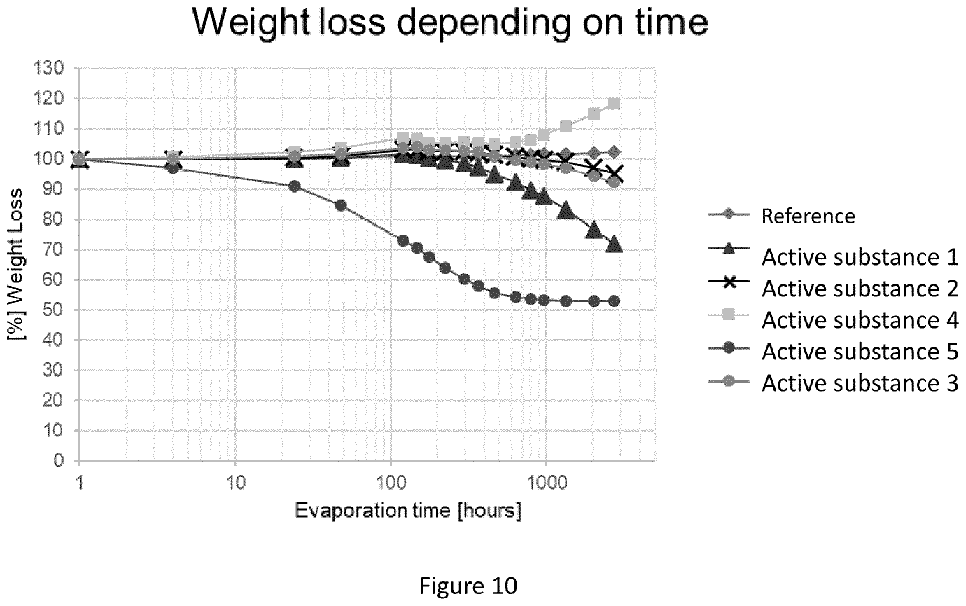

FIG. 10 presents a graph of the weight loss depending on time (adsorption at 150 degrees).

The Absorption Capacity at 150 Degrees:

The highest absorption percentage was obtained for active substance 1, 2 and 3 solutions. After the adsorption process, no free liquid is left in the bottle and the PEX particles may not have exhausted their sorption capacity. There was no significant difference between the three active substance solutions.

The active substance 5 solution received a lower adsorption rate. In the bottle there was free liquid, so it can be concluded that this is the maximum sorption capacity under these conditions.

For the active substance 4 solution, the sorption percentage is about 2/3 as compared to the absorption of the other solutions and a lot of liquid remains in the bottle.

The Evaporation Rate:

Active substance 5 evaporation began immediately and after evaporation of about 45% of the absorbent material, the evaporation rate appeared to be moderating.

In all of the samples in the walls there was a certain increase in weight, which apparently indicates moisture absorption from the air.

The weight loss begins only after about a week and at a relatively moderate pace.

In the extensive examples of active substance 1, the weight loss trend persists and even exceeds the 100% threshold of excess material-that is, at least part of the weight loss results from elongating the alcohol.

The rate of adsorption/evaporation of the active substance 3 samples is the same as that of the active substance 2 samples and the trend of weight loss continues at a relatively moderate rate.

In the extensive examples of active substance 4, weight gain persists, although for some time the weight of the sample seems to have reached equilibrium.

Active substance 4 samples Draw the active material outward.

In terms of the adsorption/evaporation behavior of the solutions themselves, behavior similar to that observed in the samples of the PEX particles is observed.

TABLE 1
Monitoring of adsorption of the active ingredient

| Active | Active | Active | Active | Active | | | |
|---|---|---|---|---|---|---|---|
| substance 3 | substance 5 | substance 4 | substance 2 | substance 1 | Material | | |
| 4.9060 | 4.7315 | 4.9811 | 5.1331 | 5.3004 | Total weight | 0 | Time of |
| 5.5871 | 1.3738 | 5.6486 | 5.7762 | 5.8646 | [g] | 72 | evaporation |
| 5.6656 | 0.5578 | 5.7412 | 5.8706 | 5.9329 | | 96 | [hours] |
| 5.2304 | 0.0847 | 5.5106 | 5.6386 | 5.6643 | | 120 | |
| 5.1742 | 0.0755 | 5.4840 | 5.5380 | 5.4672 | | 168 | |
| 5.1046 | 0.0684 | 5.4878 | 5.4452 | 5.2243 | | 240 | |
| 5.0479 | 0.0649 | 5.5312 | 5.3926 | 5.0170 | | 312 | |
| 4.8953 | 0.0568 | 5.5174 | 5.2544 | 4.6915 | | 408 | |
| 4.8440 | 0.0609 | 5.6787 | 5.2285 | 4.3878 | | 576 | |
| 4.8143 | 0.0708 | 5.8391 | 5.2141 | 4.1341 | | 744 | |
| 4.8010 | 0.0773 | 5.9937 | 5.2117 | 3.9247 | | 912 | |
| 4.8641 | 0.0981 | 6.3832 | 5.2838 | 3.5920 | | 1,272 | |
| 4.7140 | 0.0934 | 6.7360 | 5.1518 | 3.0037 | | 1,992 | |
| 4.3639 | 0.0906 | 6.9358 | 4.8389 | 2.6212 | | 2,688 | |

### Example 3

### Addition of Fragrance Substances to the PEX at 150° C.

The fragrances (substances 1-5) were absorbed by PEX particles after incubation for 4 h at 150° C., thereby resulting in absorbed PEX samples 1-5 respectively. The fragrances (essential oils and essential oil mixtures) were absorbed as described in the Test method section, with the only difference that 300 gr of PEX particles and 15 ml of a fragrance solution (having a concentration of the active fragrance substance from 5% to 15%) were used for the absorption tests. Upon absorption, PEX particles were partially dissolved (mainly the white PEX) and become a lump, which can be easily broken by shaking.

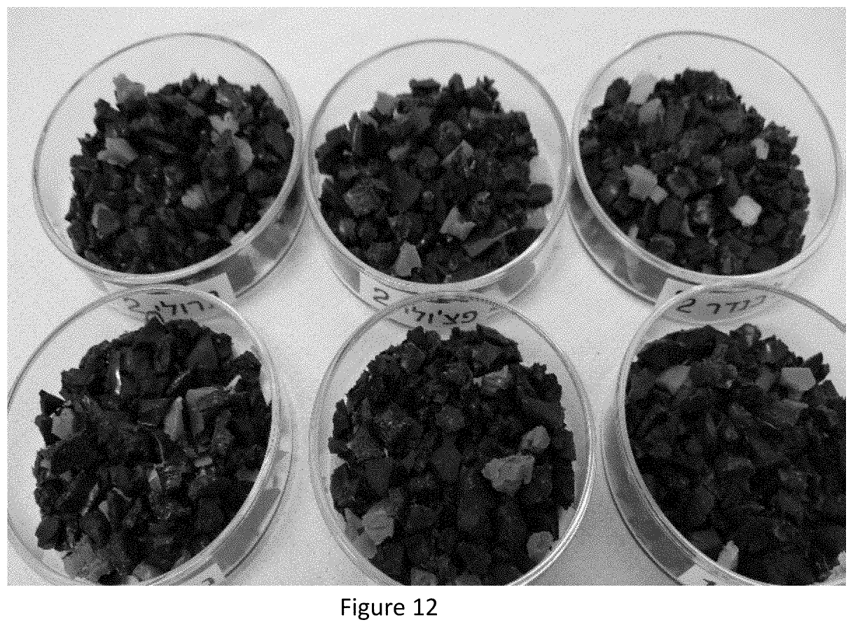

FIG. 12 shows pictures of substances 1-3 absorbed by the PEX particles.

Table 2 summarizes a weight per weight (w/w) percent of absorption of essential oils (substances 1-5) into PEX particles after 4 hours at 150° C.

| | [% w/w] of |
|---|---|
| Substance No., concentration | absorbed |
| within the solution | material |
| 1 (lavender oil), 5% | 4.2 |
| 2 (patchouli oil), 5% | 4.7 |
| 3 (neroli oil), 5% | 4.5 |
| 4 (lavender oil + patchouli oil), | 4.5 |
| 5% | |
| 5 (lavender oil + patchouli oil), | 13.4 |
| 15% | |

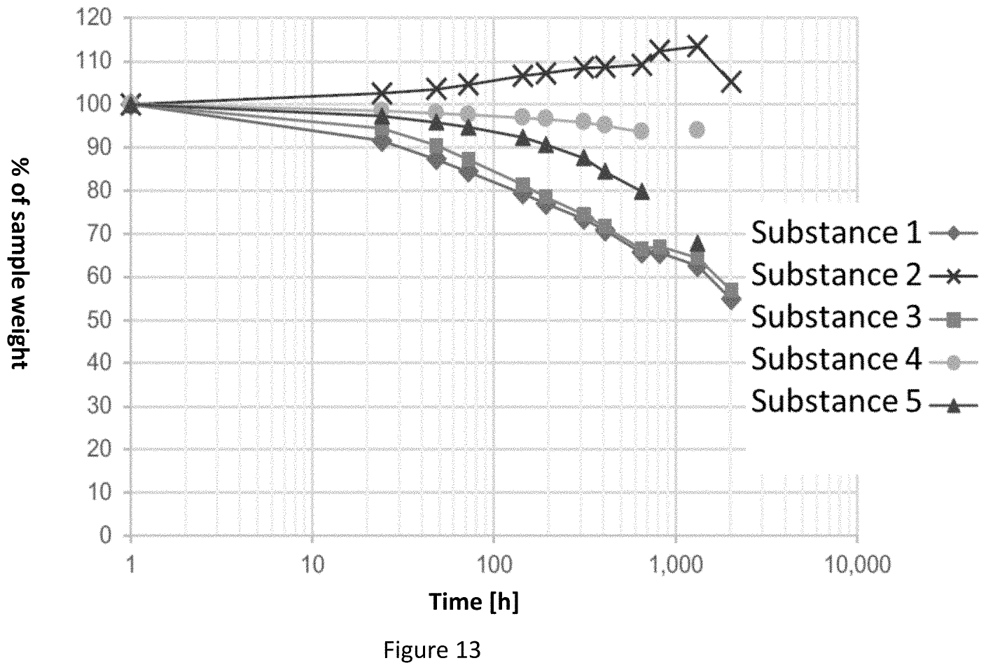

FIG. 13 presents a graph of the weight loss (in %) for each sample (1-5).

The Absorption Capacity at 150 Degrees:

The highest absorption percentage was obtained for substance 5 (1:1 mixture of substances 1 and 2) at a concentration of 15% in the fragrance solution. The same substance a concentration of 5% in the fragrance solution was characterized by a similar absorption percentage as compared to compounds 1-3 (Table 2).

The Evaporation Rate:

As apparent from FIG. 13, Sample 2 retained substantially its weight for a time period of more than 2000 h. A certain increase in weight was observed during this time period, which apparently indicates moisture absorption from the air. Samples 4 and 5 exhibited the most substantial weight loss (about 45%) after 2000 h. However, all samples retained about 90% of their weight for a time period of at least 48 h.

Samples 1, 3, 4 and 5 showed a gradual weight loss during the tested time range (FIG. 13). This observation demonstrates feasibility of using fragrance releasing compositions of the invention for a sustained release or evaporation of the fragrance substance.

### Example 4

### Addition of Perfumes to the PEX at 150° C.

The perfumes (substances 6-9) were absorbed by PEX particles after incubation for 4 h at 150° C., thereby resulting in absorbed PEX samples 6-9 respectively. The perfume substances (having a concentration of the active fragrance substance of about 15%) were absorbed within the PEX particles, as described in Example 3.

The Absorption Capacity at 150 Degrees:

Substances 6-9 exhibited a similar absorption percentage ranging from about 9 to about 12% w/w, as shown in Table 3. Surprisingly, the absorption of the perfume substances was substantially greater than the absorption of fragrances (essential oils) 1-3

| Substance | [%] of absorbed | [%] of weight loss |
|---|---|---|
| No. | material | after 3 months |
| 6 | 12.2 | Not tested |
| 7 | 12.2 | Not tested |
| 8 | 11 | 3 |
| 9 | 9.2 | 5 |

The Evaporation Rate:

For evaporation tests, the samples were stored in an open container at ambient conditions (temperature between 20 and 30° C.) for a time period of 3 months. Subsequently, the samples were subjected to an extensive evaporation to remove any residual absorbed material. The resulting particles were weighted befero and after the extensive evaporation to evaluate the percentage of the remaining absorbed material.

As apparent from Table 3, Sample 8 retained more than 70% of the absorbed perfume substance 8 for a time period of more than 2000 h. Sample 9 retained only about 40% of the absorbed perfume substance 9 during the same time period. However, both samples retained more than 95% of their weight for a time period of 48 h (data not shown).

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method for embedding a first component in a high molecular weight second component comprising the steps of:
a. mixing said first component with said high molecular weight second component, thereby obtaining a mixture;
b. heating said mixture at a heating temperature above said high molecular weight second component melting point and bellow the first component boiling point, for a period of time; and
c. cooling said mixture to room temperature, thereby embedding said first component in said high molecular weight second component.

2. The method of claim 1, further comprising the step of removing remaining non-embedded said first component.

3. The method of claim 1, wherein
said heating temperature is in the range of 0.1° C. to 200° C. above the melting temperature of said polymer.

4. The method of claim 1, wherein said first component and said high molecular weight second component are used in a ratio of 1:100 to 5:1 (w/w).

5. The method of claim 1 wherein said period of time is in the range of 20 minutes to 72 hours.

6. The method of claim 1, wherein said first component is in the form of a liquid at said heating temperature.

7. The method of claim 1, wherein said first component comprises an organic compound, water, a solvent or any combination thereof.

8. The method of claim 7, wherein said organic compound comprises a lipid, an organic oil, a salt, a wax, an essential oil, a fragrance or any combination thereof.

9. The method of claim 1, wherein 10% to 100% of the total amount of said high molecular weight second component is in the form of a solid during the process.

10. The method of claim 1, wherein 20% to 100% of the total amount of said first component is absorbed in said high molecular weight second component.

11. The method of claim 1, wherein said high molecular weight second component comprises a high molecular weight polymer.

12. The method of claim 11, wherein said high molecular weight polymer has an average molecular weight of at least 20,000.

13. The method of claim 1, wherein said high molecular weight second component comprises a crosslinked polymer.

14. The method of claim 13, wherein said polymer comprises HDPE.

15. The method of claim 1, wherein said method is performed in a closed environment.

16. The method of claim 15, wherein said closed environments is a sealed container.

17. The method of claim 1, wherein said embedding a first component in a high molecular weight second component, doesn't alter the shape of said high molecular weight second component.

18. A polymeric composition comprising a first component and a high molecular weight second component in a ratio of 1:100 to 5:1 (w/w), wherein said first component is embedded in said high molecular weight second component.

19. The composition of claim 18, in the form of a solid.

20. The composition of claim 18,
wherein said first component comprises one or more organic oils, waxes, essential oils, fragrances or a combination thereof.

21-26. (canceled)
